(19) United States
(12) Patent Application Publication
(10) Pub. No.: US 2021/0326783 A1
(43) Pub. Date: Oct. 21, 2021

(54) TOTAL MANAGEMENT SYSTEM USING UI/UX FOR SETTING MOBILITY SERVICE RECOMMENDATION AND DYNAMIC DROP-OFF LOCATION BASED ON ZONE, CONTROL METHOD THEREFOR

(71) Applicant: LG ELECTRONICS INC., Seoul (KR)

(72) Inventors: Joong Hang KIM, Seoul (KR); Sung Hwan CHOI, Seoul (KR)

(73) Assignee: LG ELECTRONICS INC., Seoul (KR)

(21) Appl. No.: 16/490,509

(22) PCT Filed: Apr. 30, 2019
(86) PCT No.: PCT/KR2019/005184

§ 371 Date: Aug. 30, 2019

(51) Int. Cl. G06Q 10/06; B60W 60/00; G01C 21/34; H04W 4/024; H04W 4/06

(52) U.S. Cl. CPC G06Q 10/0631; B60W 60/00253; G06Q 2240/00; H04W 4/024; H04W 4/06; G01C 21/3438

(57) ABSTRACT

The present invention relates to a total management system for an autonomous vehicle, the system being capable of improving mobility service convenience by combining artificial intelligence technology and robotic technology, providing an optimal mobility service to a user on a zone basis, and providing a user interface (UI)/user experience (UX) for dynamically adjusting a drop-off location while the service is in use, and a control method therefor. Also, a user terminal and an autonomous vehicle may transmit and receive data to and from a server through a wireless network using a mobile network including Code Division Multiple Access (CDMA), which is the second-generation technology, to 5G, which is the fifth-generation technology, as well as the Internet, and mobility service change details may be provided using augmented reality (AR) and virtual reality (VR).

### TECHNICAL FIELD

The present invention relates to a total management system for an autonomous vehicle, the system being capable of improving mobility service convenience by providing an optimal mobility service to a user on a zone basis and providing a user interface (UI)/user experience (UX) for dynamically adjusting a drop-off location while the service is in use, and a control method therefor.

### BACKGROUND ART

Recently, an infotainment (information+entertainment) function is applied to vehicles as a convenience function, and functions related to driver convenience such as a function of partially supporting autonomous function or a function of helping to improve the driver's vision, such as improving night vision or reducing blind spots, are being developed. For example, the driver convenience-related functions include active cruise control (ACC), smart parking assist system (SPAS), night vision (NV), head-up display (HUD), around view monitor (AVM), adaptive headlight system (AHS), and the like.

Also, as a technology for securing a driver's safety and/or a pedestrian's safety with a safety function, lane departure warning system (LDWS), lane keeping assist system (LKAS), autonomous emergency braking (AEB), and the like are being developed.

As described above, in order to support and enhance vehicular functions, improving a structural part and/or a software part of a vehicular control device may be considered. Owing to this improvement, autonomous vehicles capable of automatically traveling to destinations without driver involvement are being developed.

Autonomous driving is defined as at least one of acceleration, deceleration, and driving direction being controlled by a predetermined algorithm even though a driving operation device is not operated by a driver.

When autonomous vehicles are commercialized, a driver may utilize the time required for driving in doing something else. For example, the driver may read books, watch videos, or sleep.

Since the running and stopping of autonomous vehicles are determined not by a person but by software, there is a need for an autonomous vehicle capable of automatically performing many conventional tasks drivers have performed. Thus, various algorithms related to autonomous driving are being developed. For example, an algorithm for determining a possibility of collision with an object outside a vehicle and avoiding the collision, an algorithm for recognizing a signal or the like and performing an operation corresponding to the signal, an algorithm for adjusting spacing with a front vehicle or a rear vehicle, and the like are being developed.

U.S. Patent Publication No. 2019-0017839 (published on Jan. 17, 2019), which is mentioned in a related art document, discloses a method of providing information to a user of a traffic system using an augmented reality element.

In the related art, an augmented reality environment for a driver or a passenger including an augmented reality element is presented to display a specific position in a display of a real environment. Also, a system and method described herein analyze history information to determine the placement of augmented reality elements. Also, a user may share an augmented reality environment or a virtual reality environment with another user.

As described above, in the related art, research has been actively conducted on an autonomous vehicle capable of providing a situation occurring outside the vehicle to a user and automatically responding to the situation. However, according to the conventional technology, there are still few studies on autonomous vehicles considering passengers in the vehicles.

For example, it is anticipated that different places are assigned as a pick-up area and a drop-off area depending on a travel environment (unmanned autonomous driving, manned autonomous driving, manned manual driving, etc.) for an assigned transportation means and the type of mobility service for passengers. In this case, it is difficult for a user to find an optimal means among a variety of mobility services for movement from a current location to a destination. Therefore, when a pick-up position and a drop-off location that are initially proposed cannot be used depending on a passenger's situation, it may be difficult to dynamically respond to a mobility service in real time. As a result, the dynamic response of the system may lead to server overload.

### DISCLOSURE

### Technical Problem

The present invention relates to a total management system for an autonomous vehicle, the system being capable of improving mobility service convenience by providing an optimal mobility service to a user on a zone basis and providing a user interface (UI)/user experience (UX) for dynamically adjusting a drop-off location while the service is in use, and a control method therefor.

The present invention relates to a total management system for an autonomous vehicle, the system being capable of providing a UI/UX for presenting various mobility means that can be utilized by a user and easily determining an optimal means, and a control method therefor.

The present invention relates to a total management system for an autonomous vehicle, the system being capable of providing an intuitive UI/UX for dynamically adjusting a pick-up point and a drop-off point of the vehicle through a user terminal and a vehicular terminal, and a control method therefor.

The present invention relates to a total management system for an autonomous vehicle, the system being capable of reducing system overload due to a dynamic response and securing the quality of service (QoS) of a service by dividing an area into zones and performing computation for each zone in advance, and a control method therefor.

According to the present invention, a user terminal and an autonomous vehicle may transmit and receive data to and from a server over a wireless network using a mobile network including Code Division Multiple Access (CDMA), which is second-generation technology, to 5G, which is fifth-generation technology, as well as the Internet, and mobility service change details may be provided using augmented reality (AR) and virtual reality (VR).

The objects of the present invention are not limited to the aforementioned objects, and other objects and advantages thereof, which are not mentioned above, will be understandable from the following description and can be more clearly understood by the embodiments of the present invention. Also, it will be readily appreciated that the objects and advantages of the present invention can be realized by means and combinations thereof as set forth in the claims.

### Technical Solution

The present invention may provide user convenience by including a server configured to divide a service area into zones of various sizes, match a current location and a destination of an autonomous vehicle to each of the zones, and provide currently available mobility services and corresponding pick-up and drop-off zones, estimated routes, estimated pick-up times, and estimated fare information to a user terminal on the basis of information regarding a current location and a desired destination of a passenger of the autonomous vehicle by utilizing data pre-calculated for each of the zones.

The present invention can reduce system overload due to a dynamic response by dividing a service area into zones of various sizes, pre-calculating and pre-computing data regarding a corresponding zone, matching a current location and a destination to each of the zones when a service is requested, and maximally utilizing data pre-calculated for each of the zones.

On the basis of information regarding the current location and the desired destination of the passenger, the present invention may present currently available mobility services and corresponding pick-up zones, drop-off zones, estimated routes, estimated pick-up times, and estimated fare information and may specify and display an optimal mobility means calculated by the system.

When a distance to a destination is equal to or less than a certain level, the present invention may display a drop-off notice and a map on a user's terminal and may present drop-off candidate regions of the map as zones based on roads adjacent to the destination.

The present invention may also present an estimated route, an estimated travel time to be increased or decreased, and estimated fare information for each zone, display an optimal stop point for each zone, and propose a plurality of stop candidate points that are additionally adjustable.

The present invention may include collecting mobility service information including traffic information and region detail information input from an external server in real time and gathering the mobility service information on a region basis and on a zone basis by means of a mobility service information gathering module in a server; performing classification into a serviceable region and a non-serviceable region on the basis of traffic regulations and performing division such that usage becomes uniform on the basis of a region-specific service use frequency by means of a zone determination module in the server; adjusting a zone boundary by reflecting commercial facility distribution, traffic information, and residential population information in a corresponding zone and dividing a service area into zones on the basis of the adjusted zone boundary by means of the zone determination module in the server; gathering a mobility service including a vehicle arrival time, an estimated fare section, and a walking time for each service of a plurality of points of each of the zones from the external server by means of a mobility service information gathering module in the server; choosing a list of pick-up candidate zones and drop-off candidate zones matched to a user's current location by means of an optimal mobility service recommendation engine module and an optimal drop-off zone recommendation engine module in the server; and transmitting the chosen list of the pick-up candidate zones and the drop-off candidate zones chosen by the optimal drop-off zone recommendation engine module to an autonomous vehicle and a user terminal in a broadcasting manner by means of a message broadcaster module in the server.

### Advantageous Effects

According to the present invention, by proposing various mobility services available to the user and also proposing a pick-up area and a drop-off area for each service on a zone basis, it is possible to provide convenience in selecting an optimal service suited to his or her situation in terms of a user. Also, it is possible to increase total service utilization in terms of a service provider.

Also, by allowing a user to change or precisely adjust a pick-up point and a drop-off point on a zone basis in real time while a mobility service is in use, it is possible to secure mobility to an optimal location suitable for a real-time situation.

Also, by delivering an additional travel time, an additional fare, and mobility that are predicted according to the adjusted location to the user, it is possible to increase service quality and secure convenience.

The specific effects of the present invention in addition to the aforementioned effects will be described together with the following description of specific details for carrying out the invention.

### DESCRIPTION OF DRAWINGS

FIG. 1 is a block diagram showing a configuration of a total management system using a user interface (UI)/user experience (UX) for zone-based mobility service recommendation and dynamic drop-off location setting according to an embodiment of the present invention.

FIG. 2 is a detailed block diagram showing a configuration of a user terminal shown in FIG. 1.

FIG. 3 is a detailed block diagram showing a configuration of a server shown in FIG. 1.

FIG. 4 is a detailed block diagram showing a configuration of an autonomous vehicle shown in FIG. 1.

FIG. 5 is a flowchart illustrating a total management control method using zone-based mobility service recommendation according to an embodiment of the present invention.

FIG. 6 is a flowchart illustrating a total management control method using a UI/UX for dynamic drop-off location setting for a zone-based mobility service according to an embodiment of the present invention.

FIGS. 7A to 7E show a screen of a user terminal according to an embodiment in which final mobility is chosen during a zone change after a mobility service is requested as shown in FIG. 6.

FIGS. 8A to 8D show a screen of a user terminal according to an embodiment in which a pick-up area or a drop-off area is changed after vehicle assignment as shown in FIG. 6.

FIGS. 9A and 9B show a screen of a user terminal according to an embodiment in which a pick-up area or a drop-off area is changed after vehicle assignment as shown in FIG. 6 through an augmented reality (AR) mode.

### MODE OF THE INVENTION

The above objects, features and advantages will be described in detail below with reference to the accompanying drawings, and accordingly, those skilled in the art may easily implement the technical idea of the present invention. In describing the present invention, when it is determined that the detailed description of the known technology related to the present invention may unnecessarily obscure the scope of the present invention, a detailed description thereof will be omitted. Hereinafter, preferred embodiments of the present invention will be described in detail with reference to the accompanying drawings. In the drawings, the same reference numerals are used to indicate the same or similar elements.

In the following, when an element is described as being “connected,” “coupled,” or “joined” to another element, the elements may be directly connected or joined to each other, but it should be understood that a third element may be interposed between the elements or that the elements may be “connected,” “coupled,” or “joined” to each other via a third element.

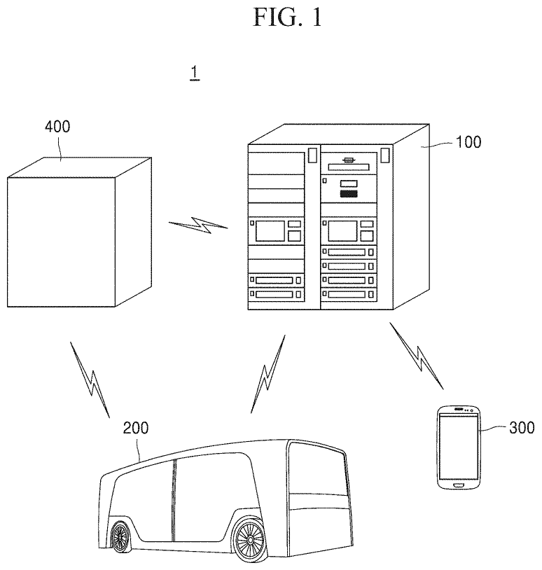

The present invention relates to a total management system using a user interface (UI)/user experience (UX) for zone-based mobility service recommendation and dynamic drop-off location setting and a control method therefor. A customized recommendation service apparatus and method applied to an autonomous vehicle according to an embodiment of the present invention will be described below in detail with reference to FIGS. 1 to 5.

FIG. 1 is a block diagram showing a configuration of a total management system using a UI/UX for zone-based mobility service recommendation and dynamic drop-off location setting according to an embodiment of the present invention.

As shown in FIG. 1, a total management system 1 of the present invention may include a server 100, an autonomous vehicle 200, a user terminal 300, and an external server 400.

The server 100, the autonomous vehicle 200, the user terminal 300, and the external server 400 constituting the customized recommendation service provision system 1 may be connected to each other through a wireless network to perform data communication with each other. In this case, the wireless network may include a mobile communication network including Code Division Multiple Access (CDMA), which is second-generation technology, to 5G, which is fifth-generation technology, as well as the Internet.

In the present invention, the user terminal may be defined as a terminal of a user who receives a customized recommendation service. That is, the user terminal 300 may be provided as one of various elements of an electronic device such as a computer, an Ultra Mobile PC (UMPC), a workstation, a netbook, a Personal Digital Assistant (PDA), a portable computer, a web tablet, a wireless phone, a mobile phone, a smartphone, an e-book, a portable multimedia player (PMP), a portable game console, a navigation device, a black box, or a digital camera that is associated with an autonomous vehicle 200 and carried by a user. However, the present invention is not limited thereto.

Also, an application for the customized recommendation service may be installed in the user terminal 300 in order to receive the customized recommendation service. The user terminal 300 is driven by a user's operation and accesses the server 100 due to the user executing the application for the customized recommendation service in a simple manner, i.e., by selecting the application displayed on a display window (screen) of the user terminal 300 in a touch or button manner.

Also, in order for the user terminal 300 to display its location provided from Global Positioning System (GPS) satellites on a map, geographic information, e.g., geographic information provided from a geographic information system (GIS) may be stored and managed. That is, by receiving location information (e.g., location coordinates) of the autonomous vehicle 200 in the form of data and displaying the data on the map stored in the terminal, the user terminal 300 may display its location and the location information of the autonomous vehicle 200 in real time. In this case, the user selects and uses a mobility service best suited to his or her situation.

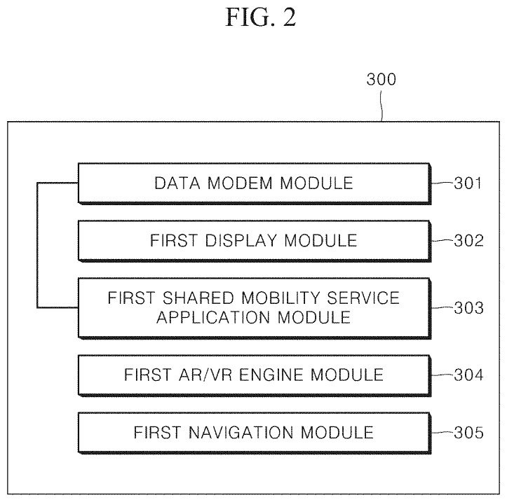

The detailed configuration of the user terminal 300 will be described below with reference to FIG. 2.

The server 100 divides a service area into zones of various sizes, and collects and computes data regarding corresponding zones in advance. Also, when a service request is input, the server matches a current location and a destination of the autonomous vehicle 200 to each of the zones. Also, the server 100 presents currently available mobility services and corresponding pick-up zones, drop-off zones, estimated routes, estimated pick-up times, and estimated fare information on the basis of information regarding a current location and a desired destination of a passenger of the autonomous vehicle 200 by utilizing data calculated in advance for each of the zones. In this case, the server 100 combines artificial intelligence with robot technologies to specify an optimal mobility means that is supplemented and calculated by means of a robot recognition function or a determination function for a mobile technology and a sensor technology and also by means of an artificial intelligence technology for processing such technologies.

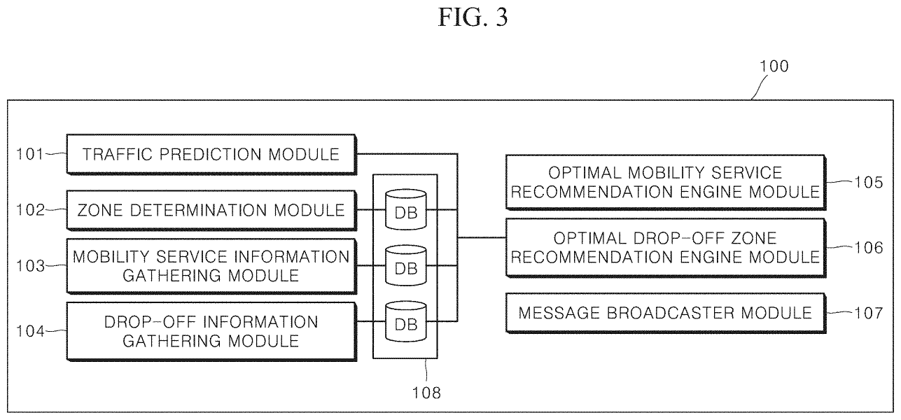

The detailed configuration of the server 100 will be described below with reference to FIG. 3.

When a distance to a destination is equal to or less than a certain level, the autonomous vehicle 200 displays a drop-off notice and a map on the user's terminal and presents the drop-off regions of the map as zones based on roads adjacent to the destination. Also, the autonomous vehicle 200 also proposes an estimated route, an estimated travel time to be increased or decreased, and estimated fare information for each zone. Also, when a drop-off zone is selected by the user, the autonomous vehicle 200 displays an optimal stop point for each zone and also proposes a plurality of stop candidate points that are additionally adjustable.

In this case, the autonomous vehicle 200 refers to a vehicle that travels to a destination by itself without a driver's intervention. The autonomous vehicle 200 may conceptually include any transportation means such as an automobile or a motorcycle. For convenience of description, it is assumed that the autonomous vehicle 200 is an automobile.

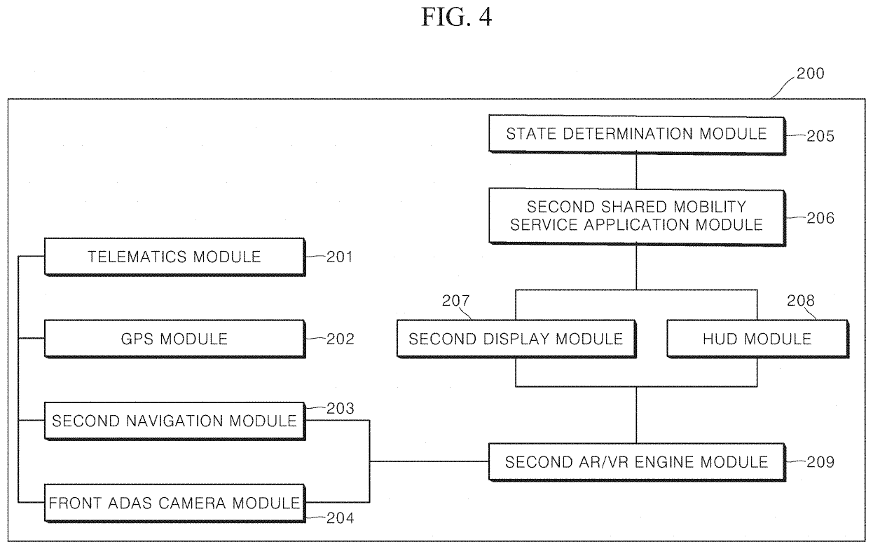

The detailed configuration of the autonomous vehicle 200 will be described below with reference to FIG. 4.

The external server 400 provides high-precision map information and provides additional information (which will be collectively described as mobility service information) about a mobility service such as traffic information and region detail information. The external server 400 may include a traffic information provision server including a road traffic information center, a high-precision map provision server including a navigation company, and a region detail information provision server.

FIG. 2 is a detailed block diagram showing a configuration of the user terminal shown in FIG. 1.

As shown in FIG. 2, the user terminal 300 includes a data modem module 301, a first display module 302, a first shared mobility service application module 303, a first augmented reality (AR)/virtual reality (VR) engine module 304, and a first navigation module 305.

The data modem module 301 is connected to the server 100 and the autonomous vehicle 200 via a wireless network to perform data communication.

On the basis of information regarding a current location and a desired destination of the user terminal 300, the first display module 302 displays currently available mobility services and corresponding pick-up zones, drop-off zones, estimated routes, estimated pick-up times, and estimated fare information and specifies and displays an optimal pick-up candidate zone calculated by the server 100 and a vehicle type provided for the pick-up candidate zone. In this case, the first display module 302 may use AR and VR to perform the displaying.

The first shared mobility service application module 303 executes an application installed in the user terminal 300, proposes an optimal mobility service to the user, and provides a UI for dynamically adjusting a drop-off location while the service is in use.

The first AR/VR engine module 304 generates changeable zones calculated on the basis of roads adjacent to the pick-up point and the drop-off point and service change details corresponding to the change according to the user's request or the system's determination by using AR and VR.

The first navigation module 305 maps the coordinates of a current location onto a prestored corresponding map using GPS or a mobile communication network. In this case, the map may include the high-precision map information and the mobility service information including the traffic information and the region detail information provided from the external server 400.

FIG. 3 is a detailed block diagram showing a configuration of the server shown in FIG. 1.

As shown in FIG. 3, the server 100 includes a traffic prediction module 101, a zone determination module 102, a mobility service information gathering module 103, a drop-off information gathering module 104, an optimal mobility service recommendation engine module 105, an optimal drop-off zone recommendation engine module 106, a message broadcaster module 107, and a storage module 108.

The traffic prediction module 101 predicts region-specific traffic by reflecting commercial facility distribution, traffic information, and residential population information using mobility service information including traffic information and region detail information input from the external server 400.

The zone determination module 102 divides a service area into zones of various sizes on the basis of region-specific traffic predicted by the traffic prediction module 101. In this case, the zone determination module 102 may perfom classification into a serviceable region and a non-serviceable region on the basis of traffic regulations and may perform the division such that usage can be uniform on the basis of a region-specific service use frequency. Also, the zone determination module 102 may adjust a zone boundary by reflecting commercial facility distribution, traffic information, and residential population information in a corresponding zone.

The mobility service information gathering module 103 collects the mobility service information including the traffic information and region detail information input from the external server 400 in real time and gathers the mobility service information on a region basis and on a zone basis. The gathered information may be stored in the storage module 108.

The drop-off information gathering module 104 collects and gathers a vehicle arrival time, an estimated fare section, a walking time, etc. for each service of a plurality of drop-off candidate points on a zone basis. The gathered information may be stored in the storage module 108.

The optimal mobility service recommendation engine module 105 chooses a pick-up candidate zone matched to a user's location on the basis of the mobility service information gathered by the mobility service information gathering module 103. In this case, the optimal mobility service recommendation engine module 105 may choose a vehicle type provided for the chosen pick-up candidate zone. The vehicle type may be chosen on the basis of the chosen zone, the location of the vehicle, predicted region-specific traffic, and the like.

The optimal drop-off zone recommendation engine module 106 chooses a drop-off candidate zone on the basis of the zone chosen by the optimal mobility service recommendation engine module 105.

The message broadcaster module 107 transmits a list of pick-up candidate zones chosen by the optimal mobility service recommendation engine module 105 and drop-off candidate zones chosen by the optimal drop-off zone recommendation engine module 106 to the autonomous vehicle 200 and the user terminal 300 in a broadcasting manner.

FIG. 4 is a detailed block diagram showing a configuration of the autonomous vehicle shown in FIG. 1.

As shown in FIG. 4, the autonomous vehicle 200 includes a telematics module 201, a GPS module 202, a second navigation module 203, an advanced driver assistance systems (ADAS) camera module 204, a state determination module 205, a second shared mobility service application module 206, a second display module 207, a head-up display (HUD) module 208, and a second AR/VR engine module 209.

The telematics module 201 transmits and receives mobility service information through wireless communication with the server 100, the user terminal 300, and the external server 400. In particular, the telematics module 201 may remotely diagnose an autonomous vehicle through the user terminal 300 and a wireless network. Also, the telematics module 201 may use a variety of information such as traffic and life information, emergency relief, and the like from the external server 400.

The GPS module 202 detects a current location of an autonomous vehicle.

The second navigation module 203 maps the coordinates of the current location of the autonomous vehicle detected by the GPS module 202 onto a prestored corresponding map. In this case, the map may include the high-precision map information and the mobility service information including the traffic information and the region detail information provided from the external server 400.

The ADAS camera module 204 captures an image in front of a moving autonomous vehicle, determines front collision, lane departure, and the like, and outputs a notification to the outside. In this case, the notification may be output to the outside through a sound device (a speaker, etc.) and a display device (a light emitting diode (LED), a liquid crystal display (LCD), etc.).

The state determination module 205 determines a vehicle driving state on the basis of transmission data and driving indication information provided by the server 100 and the user terminal 300. As an example, when a route, a pick-up location, and a drop-off location are delivered from the server 100, the state determination module 205 allows the vehicle to autonomously travel on the basis of the delivered information.

The second shared mobility service application module 206 executes an application installed in the autonomous vehicle 200, proposes an optimal mobility service to the user, and provides a UI/UX for dynamically adjusting a drop-off location while the service is in use. In this case, the second shared mobility service application module 206 may provide the same service as that of the first shared mobility service application module 303 installed in the user terminal 300.

On the basis of information regarding a current location and a desired destination of the autonomous vehicle 200, the second display module 207 displays currently available mobility services and corresponding pick-up zones, drop-off zones, estimated routes, estimated pick-up times, and estimated fare information and displays an optimal drop-off zone calculated by the server 100. In this case, the first display module 302 may use AR and VR to perform the displaying.

The HUD module 208 displays information for improving safety and convenience in driving the vehicle within a driver's field of view, for example, on the windshield of the autonomous vehicle 200.

The second AR/VR engine module 209 generates changeable zones calculated on the basis of roads adjacent to the pick-up point and the drop-off point and service change details corresponding to the change according to the user's request or the system's determination by using AR and VR.

The operation of the total management system using a UI/UX for zone-based mobility service recommendation and dynamic drop-off location setting according to the present invention will be described in detail with reference to the accompanying drawings. The same reference numerals shown in FIGS. 1 to 4 refer to the same members that perform the same functions.

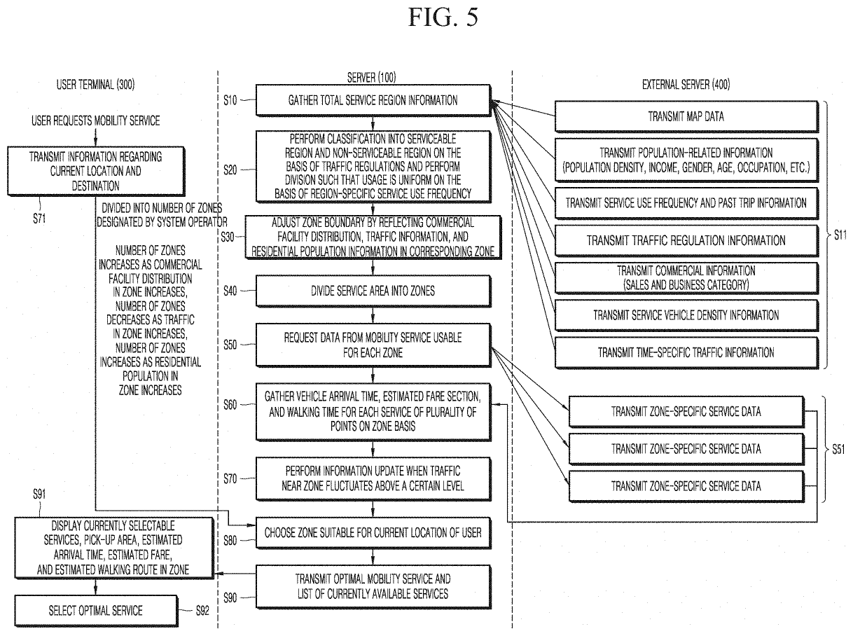

FIG. 5 is a flowchart illustrating a total management control method using zone-based mobility service recommendation according to an embodiment of the present invention. FIG. 5 is a flowchart for determining a zone-specific optimal service when a user is picked up.

Referring to FIG. 5, first, a server 100 collects mobility service information including traffic information and region detail information input from an external server 400 in real time and gathers the mobility service information on a region basis and on a zone basis by means of a mobility service information gathering module 103 (S10). In this case, the mobility service information gathering module 103 receives map data, population-related information (population density, income, gender, occupation, etc.), service use frequencies, past trip information, traffic regulation information, commercial information (sales and business category), service vehicle density information, and time-specific traffic information from the external server 400 (S11).

Subsequently, the server 100 performs classification into a serviceable region and a non-serviceable region on the basis of traffic regulations by means of a zone determination module 102. Also, the zone determination module 102 performs division such that usage can be uniform on the basis of a region-specific service use frequency.

Also, the server 100 adjusts a zone boundary by reflecting commercial facility distribution, traffic information, and residential population information in a corresponding zone by means of the zone determination module 102 (S30).

The server 100 divides a service area into zones of various sizes on the basis of the zone boundary adjusted by means of the zone determination module 102 (S40).

The server 100 requests a mobility service usable for each of the zones from the external server 400. Thus, the external server 400 transmits the mobility service requested for each zone to the server 100 (S51).

Accordingly, the server 100 gathers a mobility service such as a vehicle arrival time, an estimated fare section, a walking time, etc. for each service of a plurality of points of each zone from the external server 400 by means of a mobility service information gathering module 103 (S60).

Also, the server 100 may perform information update on the basis of the gathered mobility service information when nearby traffic fluctuates over a certain level. The server 100 may request a mobility service usable for each zone from the external server 400 again to perform information update (S70).

Subsequently, when a first shared mobility service application module 303 installed in the user terminal 300 is activated and a current location of a user and destination information are input (S81), a list of pick-up candidate zones and drop-off candidate zones matching the current location of the users is chosen through an optimal mobility service recommendation engine module 105 and the optimal drop-off zone recommendation engine module 106 (S80). In this case, the optimal mobility service recommendation engine module 105 may choose a vehicle type provided for the chosen pick-up candidate zone. The vehicle type may be chosen on the basis of the chosen zone, the location of the vehicle, predicted region-specific traffic, and the like.

Also, the server 100 transmits the chosen list of the pick-up candidate zones and the drop-off candidate zones selected by the optimal drop-off zone recommendation engine module 106 to the autonomous vehicle 200 and the user terminal 300 in a broadcasting manner by means of a message broadcaster module 107 (S90).

Thus, mobility service information associated with the zone and including currently selectable services, drop-off areas, estimated arrival times, estimated fares, estimated walking routes, etc. is displayed on the user terminal 300 and the autonomous vehicle 200.

The user may select an optimal service from the mobility service information displayed on the user terminal 300 and the autonomous vehicle 200 (S91).

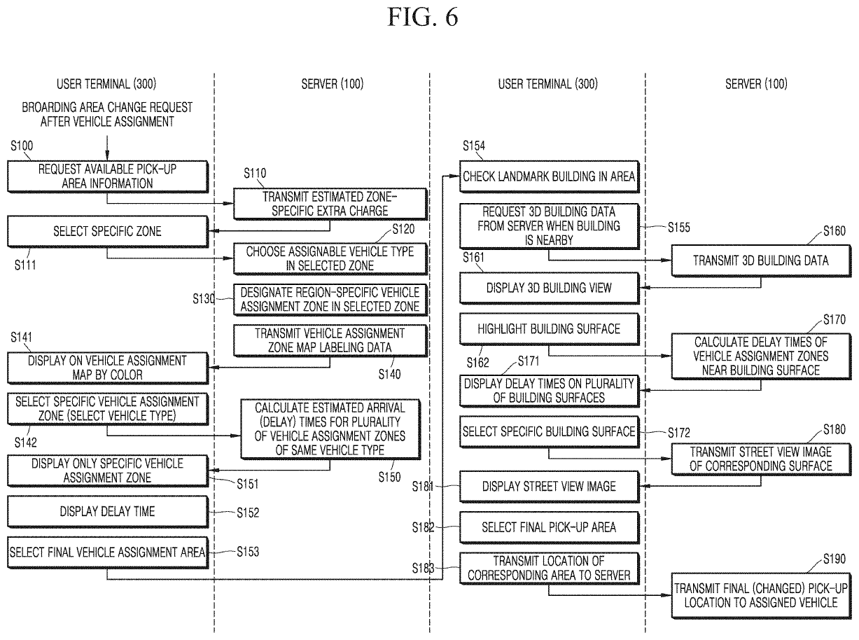

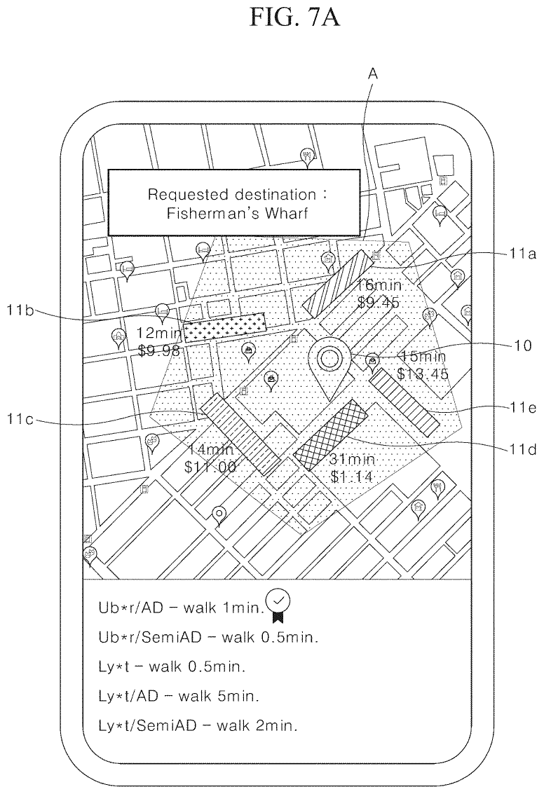

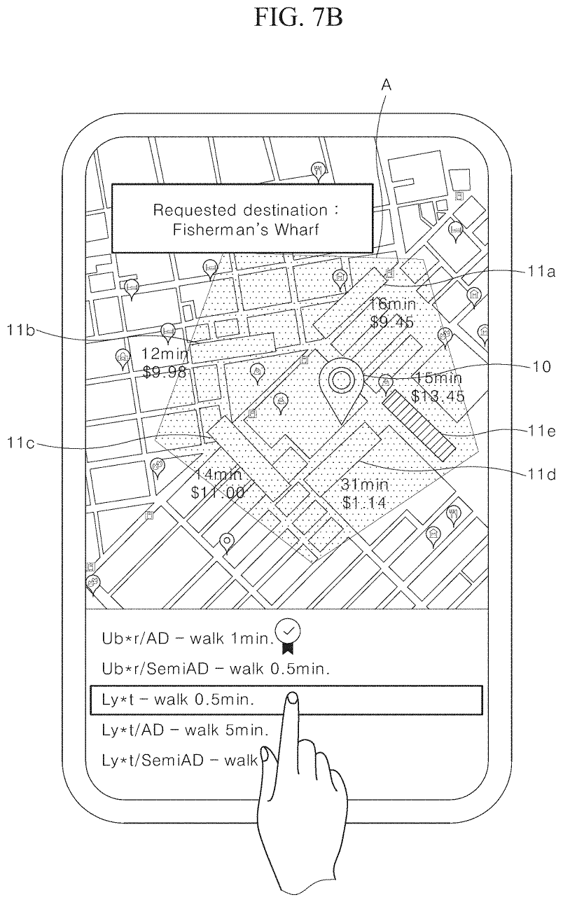

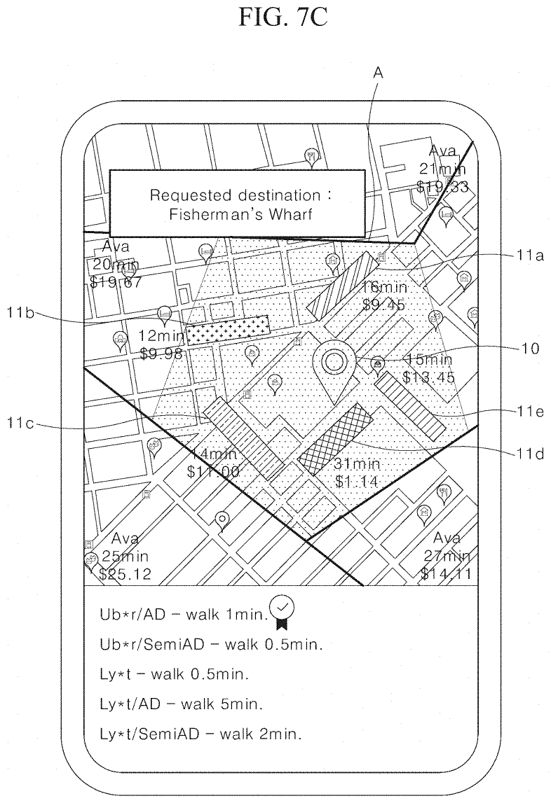

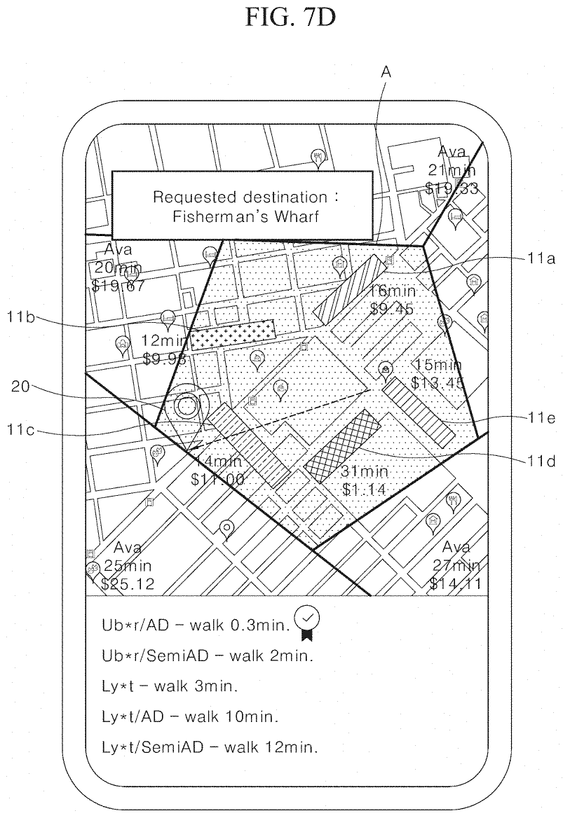

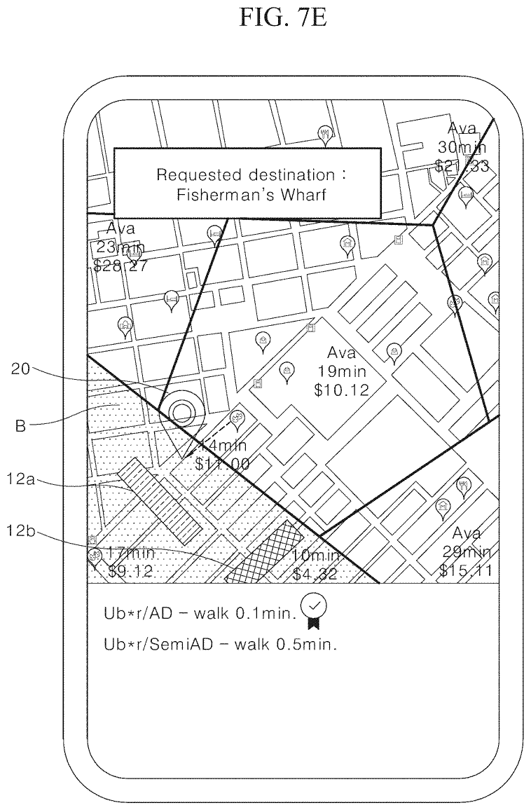

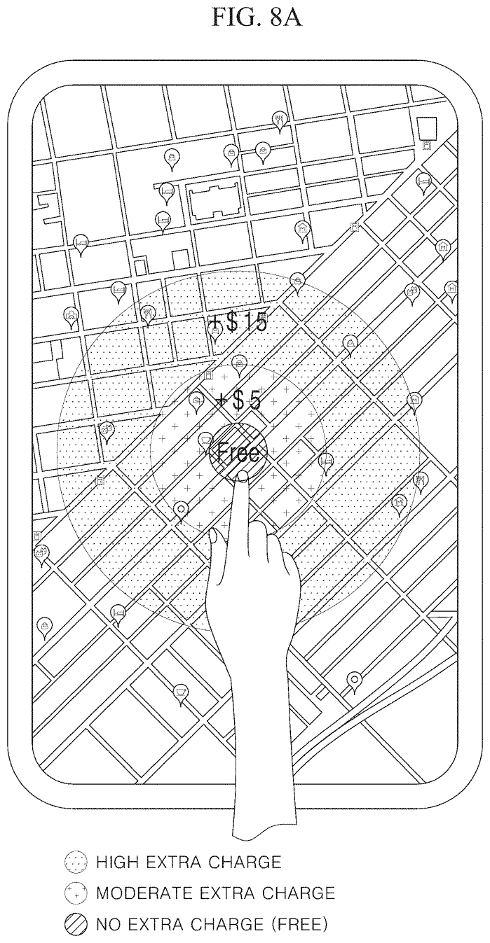

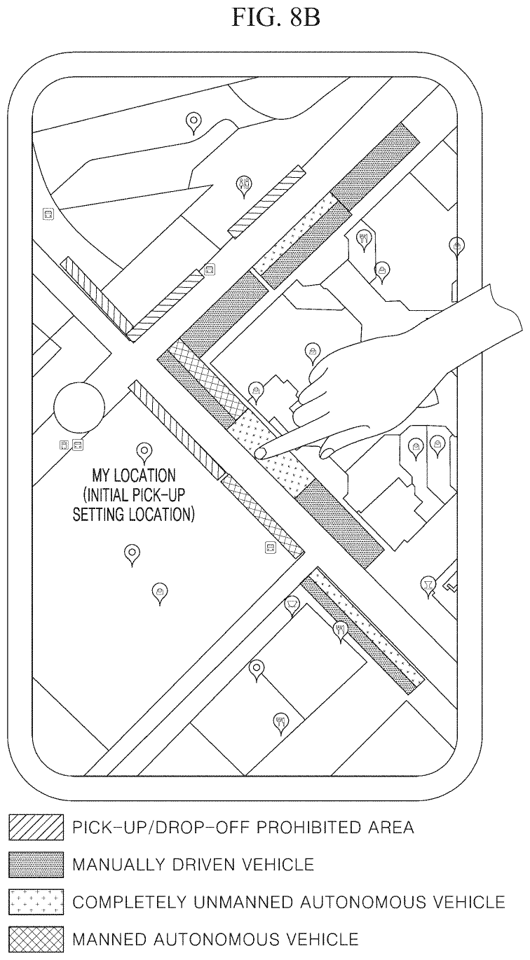

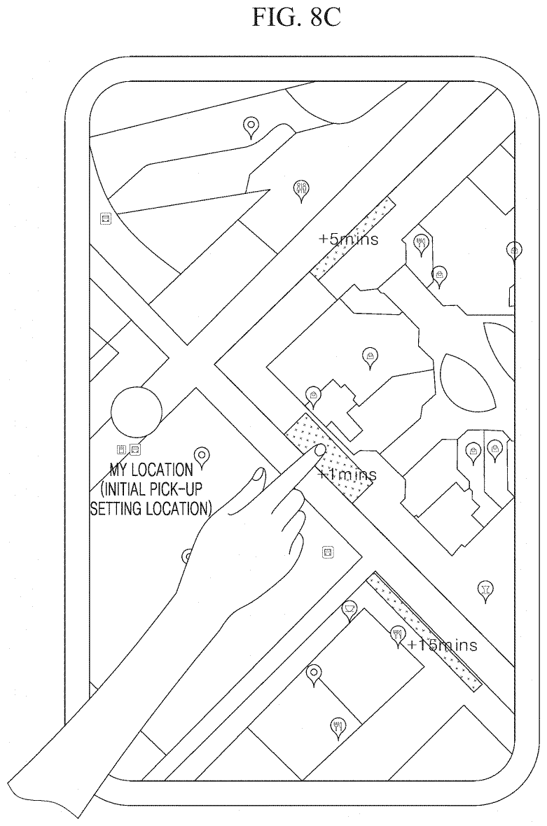

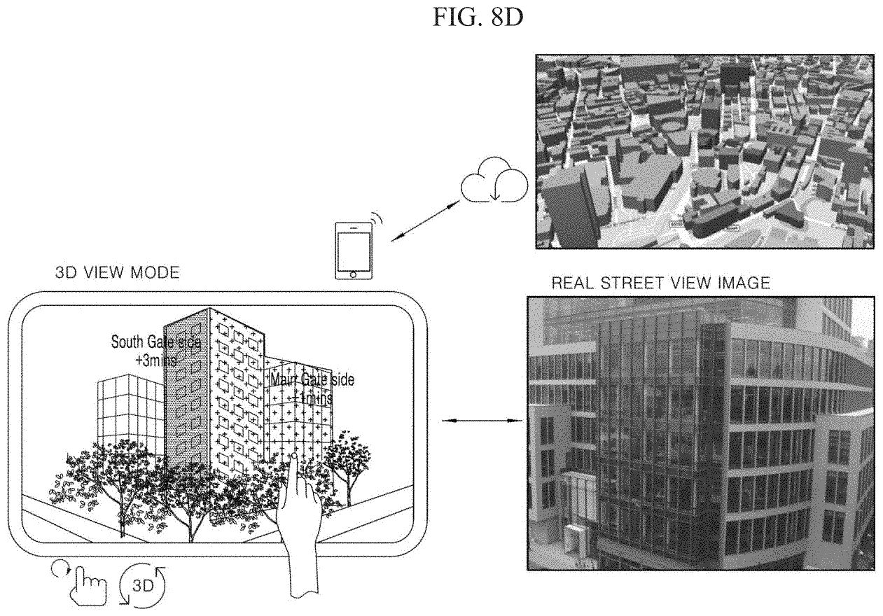

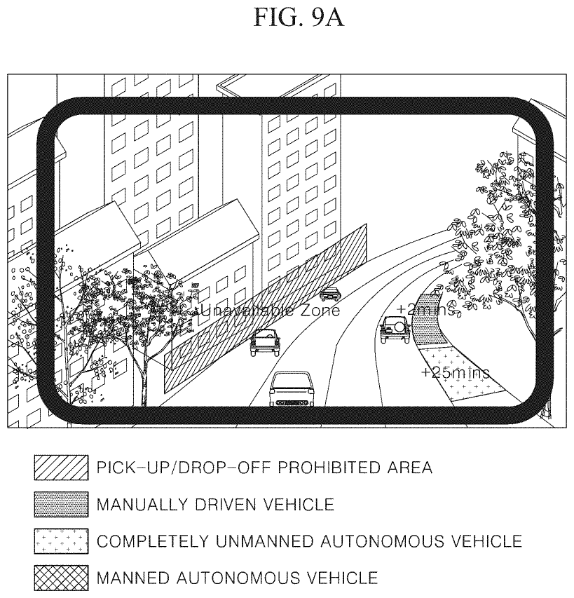

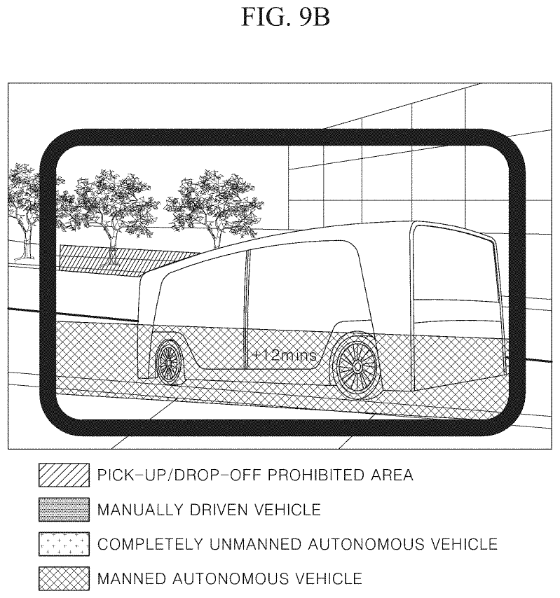

FIG. 6 is a flowchart illustrating a total management control method using a UI/UX for dynamic drop-off location setting for a zone-based mobility service according to an embodiment of the present invention. FIG. 6 is a flowchart for determining a zone-specific optimal service when a pick-up area or a drop-off area is changed after vehicle assignment. Also, FIGS. 7A to 7E show a screen of a user terminal according to an embodiment in which final mobility is selected during a zone change after a mobility service is requested as shown in FIG. 6. Also, FIGS. 8A to 8D show a screen of a user terminal according to an embodiment in which a pick-up zone or a drop-off zone is changed after vehicle assignment as shown in FIG. 6. Also, FIGS. 9A and 9B show a screen of a user terminal according to an embodiment in which a pick-up zone or a drop-off zone is changed after vehicle assignment as shown in FIG. 6 through an AR mode.

Referring to FIG. 6, after vehicle assignment as shown in FIG. 5, a user selects a change of a pick-up area through a user terminal 300 and requests information regarding changeable pick-up areas from a server 100 (S100).

Thus, the server 100 selects pick-up candidate zones matching the location of the user selected by the optimal mobility service recommendation engine module 105 among a vehicle arrival time, an estimated fare section, and walking time information for each service of a plurality of drop-off candidate points of each zone which are gathered through a drop-off information gathering module 104. Also, the server 100 transmits the selected pick-up candidate zones to a user terminal 300 by means of a message broadcaster module 107 (S110).

The user may select one of the pick-up candidate zones displayed on the user terminal 300 (S110).

As an example, as shown in FIG. 7A, the user terminal 300 displays mobility services 11a to 11e usable in zone “A” corresponding to a current location 10 at once. Also, each service may display choices such as autonomous driving, manual driving, etc. and also display a required walking time, an estimated travel time, and an estimated fare to improve selection convenience.

The server 100 chooses an assignable vehicle type of the zone selected by the user by means of an optimal mobility service recommendation engine module 105 (S130). Also, an intra-zone area-specific vehicle assignment zone is designated in the selected zone (S140). Also, the server 100 generates map labeling data of the designated intra-zone area-specific vehicle assignment zone by means of the optimal mobility service recommendation engine module 105. Also, the server 100 transmits the map labeling data to the user terminal 300 by means of the message broadcaster module 107 (S140).

In the user terminal 300, a plurality of vehicle assignment zones are displayed in a vehicle assignment zone map by color on the basis of the map labeling data of the designated intra-zone area-specific vehicle assignment zone (S141). Thus, the user may select a vehicle type and a specific vehicle zone from among the plurality of vehicle assignment zones displayed on the user terminal 300 (S142).

As an example, as shown in FIG. 7B, when a specific pick-up candidate zone “A” is selected, a corresponding service is assigned, and the user moves to use the mobility service.

Thus, the server 100 gathers a plurality of estimated vehicle assignment zone arrival (delay) times of the selected vehicle type by means of a drop-off information gathering module 104 and transmits the gathered estimated vehicle assignment zone arrival (delay) times to the user terminal 300 by means of the message broadcaster module 107 (S150).

On the user terminal 300, the selected specific vehicle assignment zone is displayed (S151), and the delay time of the displayed specific vehicle assignment zone is displayed (S152). In this case, the displayed delay time is displayed using the plurality of estimated arrival times for the vehicle assignment zone of the same vehicle type transmitted to the server 100.

Thus, the user may check the specific vehicle discharge zone and the delay time displayed on the user terminal 300 and may select a final vehicle assignment area (S153).

As an example, as shown in FIG. 7C, details about a zone based on its own location may be displayed for each service, and details about the other zones may be displayed through estimated travel times and an average fare of mobility services.

In this case, as shown in FIGS. 7D and 7E, when the selected specific zone “A” is changed to another zone “B” due to the user's movement, the zone “B” is highlighted, and details for each service newly appear in the zone “B.” Also, the highlighting of the zone “A” to which the user belonged is removed, and the estimated travel time and the average fare may be updated and then displayed.

Also, the user may check extra charges on the basis of his or her current location and the estimated travel time and fare displayed on the user terminal 300. As an example, as shown in FIG. 8A, the additional cost may be displayed as no extra charge (free), moderate extra charge, or high extra charge depending on a traveled distance with respect to a current location. Subsequently, when the user selects a location corresponding to the extra charge, a pick-up candidate location and a drop-off candidate location are displayed in the selected region as shown in FIG. 8B, and the user makes a selection. In this case, the displayed pick-up and drop-off candidate locations may be classified as options including a pick-up/drop-off prohibited area, a manually driven vehicle, a completely unmanned autonomous vehicle, and a manned autonomous vehicle.

When the user desires to change the selected location, the desire is displayed, changeable sections are displayed, and the occurrence of extra charge is output, as shown in FIG. 8C. Also, when a charge section is elected, a corresponding region in the map is enlarged, and then a pick-up area for each vehicle type may be identified by color or pattern and then displayed. Also, when the user selects a vehicle type, an area-specific pick-up delay time for a corresponding vehicle may be displayed.

Meanwhile, the user may check a landmark building within the area on the basis of a vehicle assignment zone map displayed on the user terminal 300 (S154). When the specific vehicle assignment zone is next to the building, the user may request 3D building data from the server 100 (S155).

The server 100 gathers the 3D building data requested by the user terminal 300 by means of the mobility service information gathering module 103 and transmits the gathered 3D building data to the user terminal 300 by means of the message broadcaster module 107 (S160).

A 3D building view is displayed on the user terminal 300 using the 3D building data transmitted from the server 100 (S161), and building surfaces in the displayed 3D building view are highlighted (S152). In this case, the highlighted building surfaces may indicate a pick-up area or a drop-off area.

When the server 100 gathers delay times for vehicle assignment zones adjacent to the highlighted building surfaces and transmits the gathered delay times to the user terminal 300 by means of the message broadcaster module 107 (S170), the user terminal 300 may display the delay times on the highlighted building surfaces using the delay times for the vehicle assignment zones transmitted from the server 100 (S171).

Thus, the user may select a specific building surface from among the highlighted building surfaces displayed on the user terminal 300 (S172).

The server 100 gathers a street view image corresponding to the selected specific building surface from the user terminal 300 by means of the mobility service information gathering module 103 and transmits the street view image to the user terminal 300 by means of the message broadcaster module 107 (S160). In this case, the street view image gathered using the mobility service information gathering module 103 may be provided from a high-precision map provision server of the external server 400. However, the present invention is not limited thereto, and the street image may be an image captured by an ADAS camera module of the autonomous vehicle 200.

As an example, as shown in FIG. 8D, when a building is in a pick-up area, 3D map data of a corresponding location is received from the server 100, and a 3D building module of the building is displayed on a screen of the user terminal 300. The user may select a pick-up surface of the building through touching and dragging. Also, when the surface of the building is clicked (touched), a real street view image of the corresponding surface may be additionally shown. In this case, the real street view image may also be received through the server 100.

As described above, the street view image transmitted from the server 100 may be displayed on the user terminal 300 (S181), and the user may select a final pick-up area from the street view image displayed on the user terminal 300 (S182).

The selected final pick-up area is transmitted from the user terminal 300 to the server 100 (S183), and the server 100 transmits a final vehicle assignment location (or a changed pick-up location) delivered from the user terminal 300 to the autonomous vehicle 200. Thus, the autonomous vehicle 200 executes autonomous driving (S190).

When the pick-up area is changed, the user may generate service change details through the first and second AR/VR engine modules 304 and 209 of the user terminal 300 and the autonomous vehicle 200 using AR and VR.

As an example, as shown in FIGS. 9A and 9B, when the user desires to change the pick-up location to a nearby location, the user turns on an AR or VR mode through the first and second AR/VR engine modules 304 and 209 of the user terminal 300 and the autonomous vehicle 200. Also, pick-up candidate areas for each vehicle type are highlighted in the surrounding environment using AR or VR. In this case, the highlighted areas may be classified and displayed as options including a pick-up/drop-off prohibited area, a manual vehicle, a completely unmanned autonomous vehicle, and a manned autonomous vehicle in different colors or patterns.

Also, when the user finally selects a pick-up area in a user terminal 300 mode, arrives at the pick-up area, and then desires to change the pick-up area, the above procedure may be performed again.

The present invention is not limited to the aforementioned embodiments and the accompanying drawings, and it will be apparent to those skilled in the art that various substitutions, modifications, and changes can be made without departing from the spirit of the present invention.

What is claimed is:

1. A total management system using a user interface (UI)/user experience (UX) for zone-based mobility service recommendation and dynamic drop-off location setting, the total management system comprising:
a server configured to divide a service area into zones of various sizes, match a current location and a destination of an autonomous vehicle to each of the zones, and provide currently available mobility services and corresponding pick-up and drop-off zones, estimated routes, estimated pick-up times, and estimated fare information to a user terminal on the basis of information regarding a current location and a desired destination of a passenger of the autonomous vehicle by utilizing data pre-calculated for each of the zones;
an autonomous vehicle configured to travel to a destination by itself according to a control command delivered from the server without a driver's intervention; and
an external server configured to provide high-precision map information and provide mobility service information including traffic information and region detail information.

2. The total management system of claim 1, wherein the user terminal comprises:
a data modem module configured to connect the server and the autonomous vehicle through a wireless network to perform data communication;
a first display module configured to display currently available mobility services and corresponding pick-up zones, drop-off zones, estimated routes, estimated pick-up times, and estimated fare information on the basis of information regarding a current location and a desired destination of the user terminal and configured to specify and display an optimal pick-up candidate zone calculated by the server and a vehicle type provided to the pick-up candidate zone;
a first shared mobility service application module configured to execute an application installed in the user terminal, propose an optimal mobility service to a user, and provide a UI for dynamically adjusting a drop-off location while the service is in use;
a first augmented reality (AR)/virtual reality (VR) engine module configured to generate changeable zones calculated on the basis of roads adjacent to a pick-up point and a drop-off point and service change details corresponding to the change by using AR and VR; and
a first navigation module configured to map coordinates of a current location to a prestored corresponding map.

3. The total management system of claim 1, wherein the server comprises:
a traffic prediction module configured to predict region-specific traffic by reflecting at least one of commercial facility distribution, traffic information, and residential population information using mobility service information input from the external server;
a zone determination module configured to divide a service area into zones of various sizes on the basis of region-specific traffic predicted by the traffic prediction module;
a mobility service information gathering module configured to collect the mobility service information input from the external server in real time and gather the mobility service information on a region basis and on a zone basis;
a drop-off information gathering module configured to gather at least one of a vehicle arrival time, an estimated fare section, and a walking time for each service of a plurality of drop-off candidate points of each of the zones;
an optimal mobility service recommendation engine module configured to choose a pick-up candidate zone matched to a user's location and a vehicle type provided to the pick-up candidate zone on the basis of the mobility service information collected by the mobility service information gathering module;
an optimal drop-off zone recommendation engine module configured to choose a drop-off candidate zone on the basis of the zone chosen by the optimal mobility service recommendation engine module; and
a message broadcaster module configured to transmit a list of pick-up candidate zones chosen by the optimal mobility service recommendation engine module and drop-off candidate zones chosen by the optimal drop-off zone recommendation engine module to the autonomous vehicle and the user terminal in a broadcasting manner.

4. The total management system of claim 1, wherein the autonomous vehicle comprises:
a telematics module configured to transmit and receive mobility service information through wireless communication with the server, the user terminal, and the external server;
a second navigation module configured to map coordinates of the current location of the autonomous vehicle detected through a GPS module onto a prestored corresponding map;
an advanced driver assistance systems (ADAS) camera module configured to capture an image in front of the autonomous vehicle, determine front collision and lane departure, and output a notification to the outside;
a state determination module configured to determine a vehicle driving state on the basis of transmission data and driving indication information provided by the server and the user terminal;
a second shared mobility service application module configured to execute an application installed in the autonomous vehicle, propose an optimal mobility service to the user, and provide a UI/UX for dynamically adjusting a drop-off location while the service is in use;
a second display module configured to display available mobility services and corresponding pick-up zones, drop-off zones, estimated routes, estimated pick-up times, and estimated fare information on the basis of information regarding the location and destination of the autonomous vehicle and configured to display an optimal drop-off zone calculated by the server; and
a second augmented reality (AR)/virtual reality (VR) engine module configured to generate changeable zones calculated on the basis of roads adjacent to a pick-up point and a drop-off point and service change details corresponding to the change using AR and VR.

5. A control method for a total management system using a user interface (UI)/user experience (UX) for zone-based mobility service recommendation and dynamic drop-off location setting, the control method comprising:
collecting mobility service information including traffic information and region detail information input from an external server in real time and gathering the mobility service information on a region basis and on a zone basis by means of a mobility service information gathering module in a server;
performing classification into a serviceable region and a non-serviceable region on the basis of traffic regulations and performing division such that usage becomes uniform on the basis of a region-specific service use frequency by means of a zone determination module in the server;
adjusting a zone boundary by reflecting commercial facility distribution, traffic information, and residential population information in a corresponding zone and dividing a service area into zones on the basis of the adjusted zone boundary by means of the zone determination module in the server;
gathering a mobility service including a vehicle arrival time, an estimated fare section, and a walking time for each service of a plurality of points of each of the zones on the basis of the zones from the external server by means of a mobility service information gathering module in the server;
choosing a list of pick-up candidate zones and drop-off candidate zones matched to a user's current location by means of an optimal mobility service recommendation engine module and an optimal drop-off zone recommendation engine module in the server; and
transmitting the chosen list of the pick-up candidate zones and the drop-off candidate zones chosen by the optimal drop-off zone recommendation engine module to an autonomous vehicle and a user terminal in a broadcasting manner by means of a message broadcaster module in the server.

6. The control method of claim 5, further comprising performing information update in the server on the basis of the gathered mobility service when traffic near the zone fluctuates over a certain level.

7. The control method of claim 5, wherein the optimal mobility service recommendation engine module chooses a vehicle type provided to the selected pick-up candidate zone.

8. The control method of claim 7, wherein the vehicle type is chosen on the basis of at least one of the chosen zone, a location of the vehicle, and predicted region-specific traffic.

9. The control method of claim 5, further comprising:
displaying mobility service information associated with the zone and including currently selectable services, drop-off areas, estimated arrival times, estimated fares, and estimated walking routes on the user terminal and the autonomous vehicle; and
selecting an optimal service from the mobility service information displayed on the user terminal and the autonomous vehicle.

10. The control method of claim 5, further comprising:
when a pick-up area change is requested by the user terminal, choosing pick-up candidate zones matched to the user's location chosen by the optimal mobility service recommendation engine module on the basis of the gathered vehicle arrival time, estimated fare section, and walking time for each service of a plurality of drop-off points on a zone basis by means of a drop-off information gathering module in the server;
transmitting the chosen pick-up candidate zones to the user terminal by means of the message broadcaster module in the server;
when one of the pick-up candidate zones displayed on the user terminal is selected, choosing an assignable vehicle type of the selected zone, designating an intra-zone region-specific vehicle assignment zone in the selected zone, and generating map labeling data of the designated intra-zone region-specific vehicle assignment zone by means of the optimal mobility service recommendation engine module in the server and transmitting the map labeling data to the user terminal by means of the message broadcaster module;
when a specific vehicle assignment zone is selected from among a plurality of vehicle assignment zones displayed on the user terminal and then a vehicle type is selected, gathering a plurality of estimated vehicle assignment zone arrival (delay) times of the selected vehicle type by means of a drop-off information gathering module in the server and transmitting the gathered estimated vehicle assignment zone arrival (delay) times to the user terminal by means of the message broadcaster module; and
when a final vehicle assignment area is selected in the specific vehicle assignment zone and the delay time displayed on the user terminal, transmitting a location of the selected final vehicle assignment area to the autonomous vehicle in the server.

11. The control method of claim 10, further comprising:
when 3D building data of a landmark building in an area is requested on the basis of a vehicle assignment zone map displayed on the user terminal, gathering the requested 3D building data by means of the mobility service information gathering module in the server and transmitting the gathered 3D building data to the user terminal by means of the message broadcaster module;
highlighting building surfaces in a 3D building view highlighted on the user terminal;
gathering delay times for vehicle assignment zones adjacent to the building surfaces highlighted on the user terminal in the server and transmitting the gathered delay times to the user terminal by means of the message broadcaster module; and
when a specific building surface is selected on the user terminal from among the highlighted building surfaces displayed along with the delay times, gathering a street view image corresponding to the selected specific building surface by means of the mobility service information gathering module in the server and transmitting the gathered street view image to the user terminal by means of the message broadcaster module.

12. The control method of claim 10, wherein service change details are generated using augmented reality (AR) and virtual reality (VR) through at least one of a first AR/VR engine module and a second AR/VR engine module of the user terminal and the autonomous vehicle.
